(19) United States
(12) Patent Application Publication
(10) Pub. No.: US 2009/0090725 A1
(43) Pub. Date: Apr. 9, 2009

(54) Method for Producing a Reservoir and the Thus Obtained Reservoir

(75) Inventors: Alain Ravex, Meylan (FR); Laurent Allidieres, Saint Martin D'Uriage (FR); Jean-Paul Bacca, Saint Julien De Ratz (FR)

Correspondence Address: AIR LIQUIDE;Intellectual Property, 2700 POST OAK BOULEVARD, SUITE 1800, HOUSTON, TX, 77056, US

(73) Assignee: L'Air Liquide Societe Anonyme Pour L'Etude Et L'Exploitation Des Procedes Georges Claude, Paris (FR)

(21) Appl. No.: 12/093,193

(22) PCT Filed: Oct. 24, 2006
(86) PCT No.: PCT/FR2006/051094

§ 371 Date: Nov. 10, 2008

(30) Foreign Application Priority Data
Nov. 10, 2005 (FR) 0553421

(51) Int. Cl. F17C 3/08; B21D 51/02; B21D 51/18

(52) U.S. Cl. 220/560.12; 29/469; 29/801; 220/560.13; 62/51.1; 29/773

(57) ABSTRACT

The invention relates to a method for producing a reservoir, in particular a cryogenic reservoir, provided with two concentric envelops (1, 3), i.e. the internal (1) and external (3), respectively, defining an interwall space (2) therebetween, wherein said internal space (2) is exposable to a reduced operational pressure and the internal envelop (1) is exposable to an internal positive process. The inventive method comprises a first step for calculating at least one minimum dimension characteristic of the internal envelop (1) for satisfying at least one first safety stress, a second step for calculating at least one minimum dimension characteristic of the external envelop (3) for satisfying at least one second safety stress, steps for producing the first and second envelops (1, 3) corresponding to the respective minimum dimensions calculated at the first and second steps, wherein said invention is characterized in that the second safety stress is the pressure resistance and burst resistance of the external envelop (3) for the process pressure specified for the internal envelop according to at least one standard or design rule.

The present invention relates to a method for the production of a tank, especially a cryogenic tank, and to a tank obtained using the method.

The invention relates more particularly to the production of a tank, especially a cryogenic tank, comprising two concentric walls, namely an internal wall and an external wall, defining between them an inter-wall space designed to be subjected to a working pressure, called low pressure, the internal wall being designed to be subjected to a positive internal service pressure, the method comprising:
a first design step of calculating at least one minimum dimension characteristic of the internal wall in order to meet at least a first safety constraint;
a second design step of calculating at least one minimum dimension characteristic of the external wall in order to meet at least a second safety constraint;
steps of manufacturing the internal and external walls that meet the minimum dimensions calculated in the first and second design steps respectively.

Cryogenic tanks generally consist of two concentric metal walls separated from each other by an inter-wall space. The inter-wall space under vacuum is designed for thermally insulating the inner tank, which contains the cold cryogenic fluid, from the temperature external to the tank, which is hotter. The working pressure within the inter-wall space is in general of the order of 10⁻⁵ mbar.

An insulation called multilayer insulation is in general installed in this inter-wall space so as to optimize the insulation, in particular as regards radiative heat transfer.

On-board liquid hydrogen tanks for automobile applications are of relatively small size (capacities typically between 60 and 200 liters) and have outside diameters that have to be compatible with their automobile integration (for example between 450 and 800 mm).

In general, the service pressure of the internal wall of these cryogenic tanks does not exceed 10 bar. The internal wall is conventionally designed (its thickness) with respect to the construction codes in force (for example PED or ASME) with large safety factors. This means that, for example, the internal wall must be able to withstand internal pressures of the order of four times the service pressure before bursting.

Conventionally, the external wall is designed (its thickness) so as to be able to withstand an internal vacuum (substantially zero internal pressure). This means that the external wall is designed to withstand a force of the buckling type.

The walls are generally made of metal and manufactured using the known principle of rolling for the shells and of deep-drawing for the ends. Of course, such metal walls may be manufactured using any other similar known method, for example by hydroforming.

However, the tanks of this type have a high mass, which is in particular critical for a mass-production application on motor vehicles.

One object of the present invention is to provide a method for the production of a tank that alleviates all or some of the drawbacks of the prior art mentioned above.

For this purpose, the method according to the invention, which moreover meets the generic definition given in the above preamble, is essentially characterized in that the second safety constraint is the pressure withstand capability and the burst strength of the external wall for the intended service pressure for the internal wall and in that the first safety constraint is the burst strength of the internal wall, said first safety constraint being below the second safety constraint.

According to other features:
the second safety constraint is the capability of the external wall to withstand a maximum internal service pressure determined according to at least one construction code or standard, with a first strength coefficient;
the first safety constraint is the capability of the internal wall to withstand a maximum internal service pressure determined according to at least one construction code or standard and with a second strength coefficient below said first strength coefficient;
the second strength coefficient corresponds to a rupture condition at a maximum internal service pressure of the order of twice the value of the service pressure of the internal wall;
the first safety constraint is the capability of the internal wall to withstand a defined maximum internal service pressure, which is below the second safety constraint of the external wall;
the minimum dimension characteristic of the internal wall calculated during the first design step is the thickness of said wall;
the minimum dimension characteristic of the external wall calculated during the second design step is the thickness of said wall; and
the construction code(s) or standard(s) comprise: the European PED Directive and/or the ASME construction code or the CODAP construction code or any other equivalent code or standard.

Another object of the invention is to provide a tank, especially a cryogenic tank.

According to one feature, the tank, especially a cryogenic tank, comprises two concentric walls defining between them an inter-wall space subjected to a pressure called low pressure, the tank being obtained using the method in accordance with any one of the above features.

Moreover, the invention may include one or more of the following features:
the external wall has a thickness designed to meet an internal burst pressure withstand capability according to first operating conditions and the internal wall has a thickness designed to meet an internal burst pressure withstand capability according to second operating conditions, the second operating conditions being below, in terms of pressure and/or safety, the first operating conditions; and
the internal wall and/or the internal wall comprise stainless steel and/or aluminum.

Other features and advantages will become apparent on reading the description below, given with reference to the figures in which:

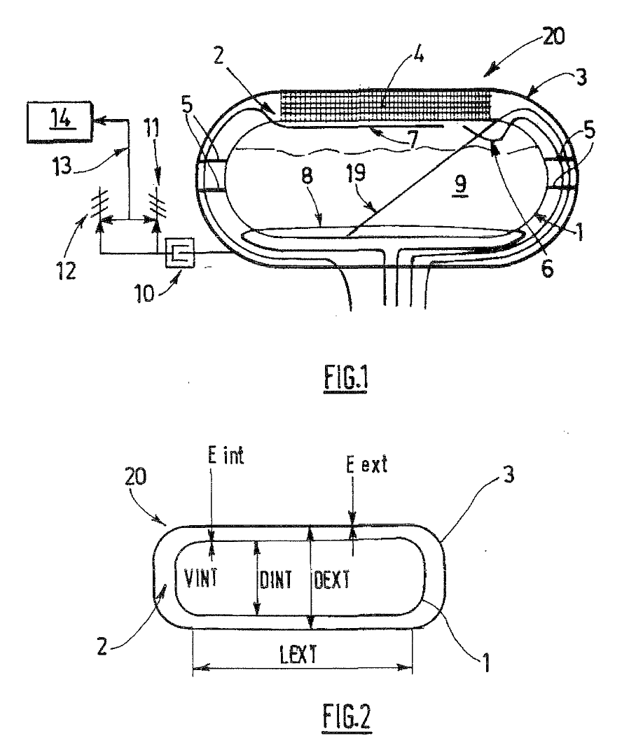

FIG. 1 shows a schematic sectional view of one exemplary embodiment of a tank according to the invention; and

FIG. 2 shows a simplified sectional view of the tank of FIG. 1 illustrating the principal dimensions of a tank.

The cryogenic tank 20 shown in FIG. 1 comprises a first, internal wall 1 intended to contain a fluid or fluid mixture 9, for example a mixture of liquid and gaseous hydrogen.

The tank 20 includes a second, external wall 3. The external wall 3 is placed concentrically around the internal wall 1. The two walls 1, 3 define between them an inter-wall space 2 in which a working pressure, called low pressure (for example a pressure of the order of 10⁻⁵ mbar) prevails.

Conventionally, the inter-wall space 2 contains means 5 forming a support for the inner tank 1. The inter-wall space 2 also contains insulation means 4, such as a conducting or non-conducting multilayer. For example, the insulation means 4 comprise a multilayer consisting of a combination of aluminized polyethylene terephthalate and glass paper.

Conventionally, the tank 20 also comprises, emerging in the internal wall 1: a filling tube 7; a gas withdrawal tube 6; a level probe 19; and a tube 8 for warming the liquid hydrogen contained in the tank so as to allow the pressure therein to be maintained as gas is being drawn off via the line 6.

The tank 20 is equipped in a known manner with a vacuum pump valve 10 and connected to a first device 11 for protecting the outer tank 3 from any overpressure (for example a valve for discharging to the atmosphere). The vacuum pump valve 10 is also connected to a second device 12 for protecting the outer tank 3 from any overpressure (for example a rupture disk or valve for discharge to the atmosphere). Both protection devices 11, 12 are connected to vents 14 via a venting line.

The Applicant has found, surprisingly and advantageously, that, at least in certain cases, employing usual design rules taken from pressure vessel codes, the calculated thickness of a wall for resistance to a service pressure (for example 10 bar) is smaller than the thickness calculated for the same tank for simple resistance to buckling with a zero internal pressure and a defined external pressure (for example an external pressure of 1 bar).

This is illustrated in more detail in Tables 1 and 2 below.

Table 1 shows a number of calculated thicknesses Eext (in mm) of an external wall 3 for meeting vacuum withstand conditions. The thicknesses were calculated for a number of geometries, namely internal volumes VINT of 50 liters, 100 liters, 150 liters and 200 liters respectively, and outside diameters Dext of 450, 500, 550, 600 and 650 mm, respectively.

TABLE 1
Calculated wall thickness Eext (in mm) of the external
wall for withstanding a vacuum

| Dext (mm) | VINT = 50 | VINT = 100 | VINT = 150 | VINT = 200 |
|---|---|---|---|---|
| 450 | 1.23 | 1.73 | 2.07 | 2.34 |
| 500 | 1.11 | 1.64 | 1.98 | 2.24 |
| 550 | 0.98 | 1.51 | 1.89 | 2.15 |
| 600 | 0.8 | 1.4 | 1.75 | 2.06 |
| 650 | 0.72 | 1.28 | 1.66 | 1.92 |

This means that for a wall enclosing a volume of 100 liters and having an outside diameter of 550 mm, the minimum thickness to meet the vacuum pressure withstand conditions is 1.51 mm.

Table 2 below shows a number of calculated thicknesses Eext (in mm) for the same external walls in order to meet pressure withstand (burst) conditions according to the CODAP construction code. The calculations were made for a service pressure of 10 bar.

TABLE 2
Calculated thickness Eext (in mm) of the external wall
for withstanding a pressure (P_{design} of 10 bar) according
to CODAP

| Dext (mm) | VINT = 50 | VINT = 100 | VINT = 150 | VINT = 200 |
|---|---|---|---|---|
| 450 | 1.43 | 1.43 | 1.43 | 1.43 |
| 500 | 1.59 | 1.59 | 1.59 | 1.59 |
| 550 | 1.75 | 1.75 | 1.75 | 1.75 |
| 600 | 1.91 | 1.91 | 1.91 | 1.91 |
| 650 | 2.07 | 2.07 | 2.07 | 2.07 |

Thus, it may be seen that in certain cases the calculated thickness of a wall for resistance to a service pressure (for example 10 bar) is smaller than the thickness calculated for the same tank for simple resistance to buckling. The critical criteria of the external wall (vacuum or pressure) are given in Table 2a below for each case.

TABLE 2a
Critical criterion

| Dext (mm) | VINT = 50 | VINT = 100 | VINT = 150 | VINT = 200 |
|---|---|---|---|---|
| 450 | Pressure | Vacuum | Vacuum | Vacuum |
| 500 | Pressure | Vacuum | Vacuum | Vacuum |
| 550 | Pressure | Pressure | Vacuum | Vacuum |
| 600 | Pressure | Pressure | Pressure | Vacuum |
| 650 | Pressure | Pressure | Pressure | Pressure |

In this table, in all the boxes denoted by “vacuum”, the vacuum design (buckling resistance) gives a greater thickness than the pressure design. Thus, for these cases, the external wall, which must withstand an external pressure of 1 bar, also makes it possible, (by regulation) to withstand an internal pressure of 10 bar. Consequently, no additional thickness is required in respect of these walls so that they also conform to the pressure vessel construction code for the envisioned design pressure in the example of 10 bar.

Starting from this information, the invention proposes that the safety conditions governing double-walled tanks be redefined by proposing that the external wall also be designed as per regulations for withstanding the maximum service pressure of the inner tank (burst resistance) instead of being specifically designed for withstanding buckling.

This means that it is not the internal wall 1 that is considered as defining the “pressure vessel”, but the external wall 3, the internal wall 1 then being considered from the standpoint of its resistance as per the regulations as a “simple accessory”. The withstand characteristics of the internal wall 1 may thus be calculated according to the invention, and not according to the rules dictated by pressure vessel codes, but according to separate rules with lower and less constricting safety factors, without thereby reducing the safety of the final tank 20.

By applying these characteristics, the invention allows thickness savings of the internal tank, and therefore weight savings for double-walled tanks, to be achieved.

Examples of weight saving from the approach described above may be summarized by the following Tables 3 to 9. These Tables 3 to 9 were obtained for the following example: AISI 316L (14404) stainless steel walls according to the CODAP thickness design code, d=7.8 representing the density of the steel in tonnes per cubic meter.

TABLE 3
Calculated weight (in kg) of the external wall for
withstanding a vacuum (d = 7.8 t/m³)

| Dext (mm) | VINT = 50 | VINT = 100 | VINT = 150 | VINT = 200 |
|---|---|---|---|---|
| 450 | 8.45 | 19.47 | 32.38 | 46.87 |
| 500 | 7.57 | 17.51 | 28.76 | 41.17 |
| 550 | 6.80 | 15.66 | 26.08 | 37.05 |
| 600 | 5.74 | 14.38 | 23.39 | 33.91 |
| 650 | 5.41 | 13.23 | 21.83 | 30.66 |

Thus, for an external wall made of stainless steel defined above, having an outside diameter Dext of 600 mm and an internal volume VINT of 200 liters, the weight of the wall calculated to meet the vacuum withstand safety condition is 33.91 kg.

TABLE 4
Calculated weight (in kg) of the external wall for
withstanding a pressure (P_{design} of 10 bar) according to
CODAP

| Dext (mm) | VINT = 50 | VINT = 100 | VINT = 150 | VINT = 200 |
|---|---|---|---|---|
| 450 | 9.82 | 16.10 | 22.37 | 28.64 |
| 500 | 10.85 | 16.97 | 23.10 | 29.22 |
| 550 | 12.14 | 18.15 | 24.15 | 30.16 |
| 600 | 13.71 | 19.62 | 25.53 | 31.44 |
| 650 | 15.56 | 21.39 | 27.23 | 33.06 |

Thus, for an external wall made of stainless steel defined above, having an outside diameter Dext of 600 mm and an internal volume VINT of 200 liters, the weight of the wall calculated to meet the pressure withstand condition (working pressure of 10 bar) is 31.44 kg.

TABLE 4a
Calculated weight (in kg) of the external wall for
withstanding a weight vacuum and pressure (P_{design} = 10 bar)
according to CODAP (d = 7.8 t/m³)

| Dext (mm) | VINT = 50 | VINT = 100 | VINT = 150 | VINT = 200 |
|---|---|---|---|---|
| 450 | 9.82 | 19.47 | 32.38 | 46.87 |
| 500 | 10.85 | 17.51 | 28.76 | 41.17 |
| 550 | 12.14 | 18.15 | 26.08 | 37.05 |
| 600 | 13.71 | 19.62 | 25.53 | 33.91 |
| 650 | 15.56 | 21.39 | 27.23 | 33.06 |

Table 4a shows the maximum values of the stresses in Tables 3 and 4, that is to say the weight of the tank withstanding both vacuum and pressure stresses according to a design code. Thus, the tank of 100 liter volume and 500 mm outside diameter has a weight of 17.51 kg (since in this case the “vacuum” stress is the critical stress, as indicated in Table 2a.

TABLE 5
Calculated weight (in kg) of the internal wall for
withstanding a pressure (P_{design} = 10 bar) according to
CODAP

| Dext (mm) | VINT = 50 | VINT = 100 | VINT = 150 | VINT = 200 |
|---|---|---|---|---|
| 450 | 8.93 | 14.63 | 20.34 | 26.04 |
| 500 | 9.76 | 15.27 | 20.77 | 26.28 |
| 550 | 11.03 | 16.49 | 21.94 | 27.40 |
| 600 | 12.56 | 17.97 | 23.39 | 28.80 |
| 650 | 14.36 | 19.74 | 25.12 | 30.50 |

Thus, for an internal wall made of stainless steel defined above, having an outside diameter Dext of 600 mm and an internal volume VINT of 200 liters, the weight of the wall 1 calculated to meet the pressure withstand condition (working pressure of 10 bar) is 28.80 kg.

Because the external wall has dimensions allowing it to meet the pressure (especially burst pressure) safety conditions, the withstand characteristics of the internal wall 1 may thus, according to the invention, be calculated with lower and less constricting safety factors (cf. the example below in Table 6).

TABLE 6
Calculated weight (in kg) of the internal wall for
withstanding a pressure (Pdesign = 10 bar) with a
reduced resistance coefficient (rupture at twice the
service pressure)

| Dext (mm) | VINT = 50 | VINT = 100 | VINT = 150 | VINT = 200 |
|---|---|---|---|---|
| 450 | 5.43 | 8.89 | 12.36 | 15.82 |
| 500 | 6.07 | 9.50 | 12.93 | 16.36 |
| 550 | 6.80 | 10.16 | 13.53 | 16.89 |
| 600 | 7.75 | 11.09 | 14.43 | 17.78 |
| 650 | 8.87 | 12.20 | 15.52 | 18.84 |

In Table 6, the weight of the internal wall was designed to meet pressure withstand conditions with a downgraded rupture coefficient (equal to only twice the surface pressure). By way of comparison, the “normal” rupture coefficient used in Table 5 is around 4 times the service pressure (P_{design}=10 bar in this example).

This means that, for an internal wall 1 made of stainless steel defined above having an outside diameter Dext of 600 mm and an internal volume VINT of 200 liters, the weight of the wall 1 designed to meet the downgraded pressure withstand condition (working pressure of 10 bar) is 17.78 kg.

The weight of the “final” tank (only the two walls are considered) according to the prior art is therefore the sum (in kg) of the design weight of the external wall 3 for withstanding a vacuum and the design weight of the internal wall 1 for withstanding a pressure (sum of the weights given in Tables 3 and 5 and given in Table 7).

TABLE 7
Total weight (in kg) of the “conventional” tank

| Dext (mm) | VINT = 50 | VINT = 100 | VINT = 150 | VINT = 200 |
|---|---|---|---|---|
| 450 | 17.38 | 34.10 | 52.72 | 72.91 |
| 500 | 17.33 | 32.77 | 49.54 | 67.45 |
| 550 | 17.83 | 32.14 | 48.03 | 64.45 |
| 600 | 18.30 | 32.35 | 46.78 | 62.71 |
| 650 | 19.77 | 32.97 | 46.95 | 61.16 |

Thus, for a tank according to the prior art having an outside diameter Dext of 600 mm and an internal volume VINT of 200 liters, the total weight (internal wall+external wall) is equal to 33.91+28.80=62.71 kg.

In contrast, the “total” weight of the tank obtained by the manufacturing method according to the invention is, in each case, the sum of the design weight of the external wall 3 for withstanding a pressure (P_{design}=10 bar) and for withstanding a vacuum and of the design weight of the internal wall 1 for withstanding a pressure (P_{design}=10 bar) with a reduced or downgraded resistance coefficient (i.e. the sum of the weights in Tables 4a and 6 and given in Table 8).

TABLE 8
Total weight (in kg) of the tank according to the
invention

| Dext (mm) | VINT = 50 | VINT = 100 | VINT = 150 | VINT = 200 |
|---|---|---|---|---|
| 450 | 15.25 | 28.36 | 44.74 | 62.69 |
| 500 | 16.92 | 27.01 | 41.69 | 57.53 |
| 550 | 18.94 | 28.31 | 39.61 | 53.94 |
| 600 | 21.46 | 30.71 | 39.96 | 51.69 |
| 650 | 24.43 | 33.59 | 42.75 | 51.9 |

Thus, for a tank according to the invention having an outside diameter Dext of 600 mm and an internal volume VINT of 200 liters, the total weight (internal wall+external wall) is equal to 33.91+17.78=51.69 kg.

Thus, the tank according to the invention provides a weight saving of around 17.5% over the prior art without reducing the safety factors of said tank (for example by simply comparing the weights indicated in Tables 7 and 8).

Table 9 below illustrates the percentage weight savings obtained for each geometry according to the invention.

TABLE 9
Percentage weight saving obtained according to the
invention over the prior art (base: weight of the tank
according to the prior art)

| Dext (mm) | VINT = 50 | VINT = 100 | VINT = 150 | VINT = 200 |
|---|---|---|---|---|
| 450 | −12% | −17% | −15% | −14% |
| 500 | −02% | −18% | −16% | −15% |
| 550 | +06% | −12% | −18% | −16% |
| 600 | +17% | −05% | −15% | −18% |
| 650 | +24% | +02% | −09% | −15% |

This shows that the manufacturing method according to the invention allows weight savings in almost all the configurations. In the cases in which the method according to the invention leads to an increase in weight of the tank (Dext=550, 600 or 650 liters and VINT=50 liters or Dext=650 liters and VINT=100 liters), the method according to the prior art may be preferred. The method according to the invention may also include a step of comparing the design weight of the tank obtained according to the invention with the weight of a tank obtained according to the prior art and a step of manufacturing the tank according to the invention only when the design weight of the tank obtained according to the invention is equal to or less than the weight of a tank obtained according to the prior art.

The invention may apply to any type of tank having two walls and irrespective of the geometry of the tank, having an external length Lext, an outside diameter Dext, an external thickness Eext, an inside diameter DINT, an internal thickness Eint and an internal volume VINT (cf. FIG. 2).

The invention applies to tanks in which the internal wall and/or the internal wall consists of any type of stainless steel and/or aluminum grade or of any other material.

1-12. (canceled)

13. A method for the production of a tank, especially a cryogenic tank, comprising two concentric walls, namely an internal wall and an external wall, defining between them an inter-wall space designed to be subjected to a working pressure, called low pressure, the internal wall being designed to be subjected to a positive internal service pressure, the method comprising:
a first design step of calculating at least one minimum dimension characteristic of the internal wall in order to meet at least a first safety constraint;
a second design step of calculating at least one minimum dimension characteristic of the external wall in order to meet at least a second safety constraint;
steps of manufacturing the internal and external walls that meet the minimum dimensions calculated in the first and second design steps respectively, characterized in that the second safety constraint is the pressure withstand capability and the burst strength of the external wall for the intended service pressure for the internal wall and in that the first safety constraint is the burst strength of the internal wall, said first safety constraint being below the second safety constraint.

14. The production method of claim 13, wherein the second safety constraint is the capability of the external wall to withstand a maximum internal service pressure determined with a first strength coefficient defined for example according to at least one construction code or standard.

15. The production method of claim 14, wherein the first safety constraint is the capability of the internal wall to withstand a maximum internal service pressure determined with a second strength coefficient below said first strength coefficient defined for example according to the same construction code or standard as for the second constraint.

16. The production method of claim 15, wherein the second strength coefficient corresponds to a rupture condition at a maximum internal service pressure of the order of twice the value of the service pressure of the internal wall.

17. The production method of claim 13, wherein the first safety constraint is the capability of the internal wall to withstand a defined maximum internal service pressure, which is below the second safety constraint of the external wall.

18. The production method of claim 13, wherein the minimum dimension characteristic of the internal wall calculated during the first design step is the thickness of said wall.

19. The production method of claim 13, wherein the minimum dimension characteristic of the external wall calculated during the second design step is the thickness of said wall.

20. The method of claim 13, wherein the external wall is made of a composite and optionally includes a metal and/or plastic liner.

21. The method of claim 13, wherein the internal wall is made of metal.

22. A tank, especially a cryogenic tank, comprising two concentric walls defining between them an inter-wall space subjected to a pressure called low pressure, wherein it is obtained using the method of claim 13.

23. The tank of claim 22, wherein the external wall has a thickness designed to meet an internal burst pressure withstand capability according to first operating conditions and in that the internal wall has a thickness designed to meet an internal burst pressure withstand capability according to second operating conditions, the second operating conditions being below, in terms of pressure and/or safety, the first operating conditions.

24. The tank of claim 21, wherein the internal wall and/or the internal wall comprise stainless steel and/or aluminum and/or a composite.
